(19) United States
(12) Patent Application Publication
(10) Pub. No.: US 2002/0174289 A1
(43) Pub. Date: Nov. 21, 2002

(54) Method and apparatus to enhance testability and validation of memory

(76) Inventor: David G. Chow, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/862,408

(22) Filed: May 21, 2001

(51) Int. Cl. G06F 12/00

(52) U.S. Cl. 711/104

(57) ABSTRACT

A memory device to receive a value from a programmable register, the value defines an operational characteristic of the memory device.

### BACKGROUND OF THE INVENTION

1. Field of the Invention The present invention relates to testability and validation improvements, and specifically to a method and apparatus of utilizing programmable registers to efficiently test and validate memory devices or embedded memory.

2. Description of the Related Art

As the technology for manufacturing integrated circuits advances, more logic functions are included in a single integrated circuit device. Modem integrated circuit (IC) devices include large numbers of gates on a single semiconductor chip, with these gates interconnected so as to perform multiple and complex functions. The fabrication of an IC incorporating such Very Large Scale Integration (VLSI) must be error free, as a manufacturing defect may prevent the IC from performing all of the functions that an IC is designed to perform. Such demands require verification of the design of the IC and also various types of electrical testing after the IC is manufactured.

However, as the complexity of the IC increases, so does the cost and complexity of verifying and electrically testing each of the devices in the IC. Electrical testing ensures that each node in a VLSI circuit functions properly. Therefore, each node needs to individually, and in conjunction with the other node in the IC, function properly in all possible combinations of operations. Typically, electrical testing is performed by automated testing equipment (ATE) that employs test vectors to perform the desired tests. A test vector describes the desired test input (or signals), associated clock pulse (or pulses), and expected test output (or signals) for every package pin during a period of time, often in an attempt to “test” a particular node. For complex circuitry, this may involve a large number of test vectors and, accordingly, a long test time.

Test, design, and validation engineers struggle with validating semiconductor devices due to the problems such as: complex and dynamic manufacturing processes, design complexity, and new test equipment and test programs. As the desire for introducing new products to the market increases, the companies need to reduce the test and validation cycle by minimizing the design revisions with more efficient and reliable means of detecting faults and design errors.

### BRIEF DESCRIPTION OF THE SEVERAL VIEWS OF THE DRAWINGS

The present invention is illustrated by way of example and not limitation in the following figures. Like references indicate similar elements, in which:

FIG. 1 illustrates a block diagram utilized by an embodiment of the present invention.

### DETAILED DESCRIPTION OF THE INVENTION

A method and apparatus for increased ability to efficiently test and validate memory devices or embedded memory with programmable registers are described. In the following description, for purposes of explanation, numerous details are set forth in order to provide a thorough understanding of the present invention. However, it will be apparent to one skilled in the art that these specific details are not required in order to practice the present invention.

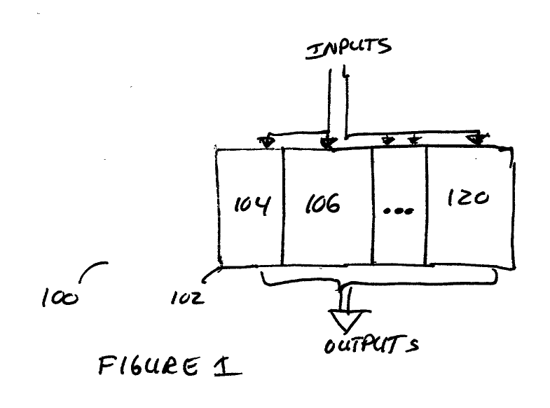

FIG. 1 illustrates a block diagram 100 utilized by an embodiment of the present invention. The block diagram 100 comprises a register 102 with a plurality of n locations 104, 106, and 120. In one embodiment, the register 102 is on a memory device with a memory array and the register is programmable. In another embodiment, the register 102 is coupled to a memory device and the register is programmable. In one embodiment, the memory device is a dynamic random access memory. In another embodiment, the memory device is a static random access memory. In yet another embodiment, the memory device is a polymer memory, supplied by Thinfilm Electronics, and the memory device is manufactured by Intel.

The register receives inputs from the memory device or from external pins of the memory device, or from both. Also, the register is coupled to the internal logic and to the memory array of the memory device. In one embodiment, the storage locations are externally read and written in binary format and are internally converted by the semiconductor device to Gray code. As is known in the art, Gray code is a binary format, which allows for only one bit of data within a field to change value during a clock cycle. In one embodiment, while read and write operations are occurring to the register 102, access to memory array logic such as address decoders is disabled.

In one embodiment, the register 102 is programmable and is initialized to user defined default values in response to a reset of the memory device. A read operation of a single location or a plurality of locations of register 102 is achieved by accessing one or more of the plurality of storage locations 104,106, and 108. In one embodiment, at least one storage location defines a particular mode of operation for the memory device. For example, a mode defines a dual read mode wherein the memory device performs two successive reads to the same address location and the second read is subtracted from the first read in order to extract the desired signal. Another example of a mode is a self-test mode to enable the memory device to perform self-test operations.

In another embodiment, operational characteristics are stored in the locations 104-120. For example, a read operation requires sensing memory cells to interpret the data. A sensing operation is performed on the memory cell by transferring the charge from the memory cell to the sense amplifiers via a bitline. Also, operational characteristics of the memory device such as sensing time, bitline settling time, bitline precharge field, and dual sensing operations can be stored in the locations 104-120 to define the sensing operation or any memory operation. One advantage of programming the locations with the operational characteristic values is test and validation flexibility because the engineer can instantly revise the value and verify the functionality of the memory device. Also, this minimizes the need to power down the device because the programming feature of the locations allows for real time revisions.

In one embodiment, a write operation to a storage location of register 102 is achieved by utilizing input/output pins to supply an address and data for the write operation. Thus, the register 102 is addressable, but is not in the address space of the memory array.

In one embodiment, the locations 104-120 define counter values based on a clock. The counter values are used to define a plurality of timing edges for read and write operations to the memory device. For example, a bitline precharge value is stored in a location or a plurality of locations within register 102. The bitline precharge value from the one or more of the storage location(s) is loaded into an internal down counter, which proceeds to counting down to zero. When the counter reaches a zero value, an internal state machine detects the zero value and proceeds to the next state. Thus, the counter values stored in the register 102 allow for an efficient and reliable internal timing edge generation and minimize design errors due to inconsistent timing edges. In another embodiment, the locations 104-120 define values, which are loaded into a count up counter.

One skilled in the art would appreciate utilizing various embodiments. For example, the register 102 can store a variety of data related to the operation or characteristics of the memory device or embedded memory. Also, the locations within the register 102 can be used to define timing edges without the need for an internal down counter. In another embodiment, the memory device does not internally convert the values of the locations to Gray code.

While the invention has been described with reference to specific modes and embodiments, for ease of explanation and understanding, those skilled in the art will appreciate that the invention is not necessarily limited to the particular features shown herein, and that the invention may be practiced in a variety of ways that fall under the scope and spirit of this disclosure. The invention is, therefore, to be afforded the fullest allowable scope of the claims that follow.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486 ; Sanjeet Dutta, Reg. No. P46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George B. Leavell, Reg. No. 45,436; Kurt P. Leyendecker, Reg. No 42,799; Gordon R. Lindeen III, Reg. No. 33,192; Jan Carol Little, Reg. No. 41,181; Robert G. Litts, Reg. No. 46,876; Julio Loza, Reg. No. 47,758; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Edwin H. Taylor, Reg. No. 25,129; Lance A. Termes, Reg. No. 43,184; John F. Travis, Reg. No. 43,203; Joseph A. Twarowski, Reg. No. 42,191; Kerry D. Tweet, Reg. No. 45,959; Mark C. VanNess, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafmnan, Reg. No. 26,250; my patent attorneys, and Firasat Ali, Reg. No. 45,715; Richard Nakashima, Reg. No. 42,023, my patent agents of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and and Alan K. Aldous, Reg. No. 31,905; Robert D. Anderson, Reg. No. 33,826; Joseph R. Bond, Reg. No. 36,458; Richard C. Calderwood, Reg. No. 35,468; Jeffrey S. Draeger, Reg. No. 41,000; Cynthia Thomas Faatz, Reg No. 39,973; Sean Fitzgerald, Reg. No. 32,027; John N. Greaves, Reg. No. 40,362; John F. Kacvinsky, Reg No. 40,040; Seth Z. Kalson, Reg. No. 40,670; David J. Kaplan, Reg. No. 41,105; Charles A. Mirho, Reg. No. 41,199; Leo V. Novakoski, Reg. No. 37,198; Naomi Obinata, Reg. No. 39,320; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Steven C. Stewart, Reg. No. 33,555; Raymond J. Wemer, Reg. No. 34,752; Robert G. Winkle, Reg. No. 37,474; Steven D. Yates, Reg. No. 42,242, and Charles K. Young, Reg. No. 39,435; my patent attorneys, Thomas Raleigh Lane, Reg. No. 42,781; Calvin E. Wells; Reg. No. P43,256, Peter Lam, Reg. No. 44,855; Michael J. Nesheiwat, Reg. No. P47,819; and Gene I. Su, Reg. No. 45,140; my patent agents, of INTEL CORPORATION; and James R. Thein, Reg. No. 31,710, my patent attorney; with full power of substitution and revocation, to prosecute this application and to transact all business in the Patent and Trademark Office connected herewith.

1. An apparatus comprising:
a memory device; and
a programmable register, coupled to the memory device, with a plurality of locations to store a value in one of the plurality of locations to define an operational characteristic of the memory device.

2. The apparatus of claim 1 wherein the value is transferred from one of the plurality of locations to a down counter.

3. The apparatus of claim 1 wherein the value is a binary format external to the memory device.

4. The apparatus of claim 1 wherein the value is converted from a binary format to a Gray code format internal to the memory device.

5. The apparatus of claim 1 wherein the operational characteristic is either a sensing time, bitline settling time, or a bitline precharge time.

6. The apparatus of claim 1 wherein the memory device is a dynamic random access memory device.

7. The apparatus of claim 1 wherein the memory device is a static random access memory device.

8. The apparatus of claim 1 wherein the memory device is a polymer memory, the polymer manufactured by ThinFilm Electronics Corporation, and the polymer memory device manufactured by Intel Corporation.

9. The apparatus of claim 1 wherein the value in the internal down counter represents a delay to generate a timing edge for a memory read or write operation.

10. A method comprising:
storing a value in a programmable register;
generating an operation for a memory in response to the value; and
processing a memory operation in response to the operational characteristic.

11. The method of claim 10 further comprising:
loading the value from the programmable register to a down counter.

12. The method of claim 10 further comprising:
decrementing the value in the down counter.

13. The method of claim 12 further comprising:
generating a timing edge with respect to the value in the down counter

14. The method of claim 10 wherein the operation is a mode, timing edge generation, or an operational characteristic of the memory device.

15. The method of claim 10 wherein the memory is a dynamic random access memory.

16. The method of claim 10 wherein the memory is a static random access memory.

17. The method of claim 10 wherein the memory device is a polymer memory, the polymer manufactured by ThinFilm Electronics Corporation, and the polymer memory device manufactured by Intel Corporation.

18. An apparatus comprising:
a memory module, coupled to a programmable register with a plurality of locations, and at least one location to store a value, the memory module further comprising:
a plurality of memory devices to perform a memory operation in response to the value.

19. The apparatus of claim 18 wherein the value is loaded into a down counter to define a timing edge for a read or write operation.

20. The apparatus of claim 18 wherein the value is a mode of operation and is a self-test mode or a dual read mode.

21. The apparatus of claim 18 wherein the value is loaded into a count up counter.

22. The apparatus of claim 18 wherein the memory device is a polymer memory, the polymer manufactured by ThinFilm Electronics Corporation, and the polymer memory device manufactured by Intel Corporation.
